(19) United States
(12) Patent Application Publication
(10) Pub. No.: US 2006/0136293 A1
(43) Pub. Date: Jun. 22, 2006

(54) System and method for predictive product requirements analysis

(76) Inventor: Kasra Kasravi, West Bloomfield, MI (US)

Correspondence Address: STEPHEN R. LOE, THE LAW OFFICE OF STEPHEN R. LOE, P.O. BOX 649, FRISCO, TX, 75034, US

(21) Appl. No.: 11/019,144

(22) Filed: Dec. 21, 2004

(51) Int. Cl. G06Q 30/00; G07G 1/00

(52) U.S. Cl. 705/14; 705/10

(57) ABSTRACT

A method, system, and computer program product for capturing consumer product preferences over a period of time and analyzing consumer product preferences over a period of time in order to predict future product and service requirements is provided. In one embodiment, individual consumer product preference inputs from a plurality of consumers are collected over time via a user-interface tool, such as, for example, a web-based tool. The inputs are stored in a storage unit, such as, for example, a database. After a specified period of time or after a threshold number of inputs have been received, the consumer product preference inputs are retrieved from the storage unit and reduced into representative clusters to facilitate predicting future product requirements and to do trend analysis to extrapolate the change of the cluster over time.

### BACKGROUND OF THE INVENTION

1. Technical Field

The present invention relates generally to the field of computer software and, more specifically, to the field of product development and, even more specifically, to a method and a process for predictive product requirements analysis.

2. Description of Related Art

Product companies have historically needed to predict consumers' demands, in order to produce successful products. This challenge is rooted in the disconnect between product development time and the dynamic nature of the consumers' demands. Therefore, a product company that develops a product for today's demands may not produce the product that the market demands at the time that the product is released. This problem is more critical in products that have long development cycles, such as passenger vehicles.

Due to the time and capital investments involved in developing and marketing products, it is critical for product companies to have an accurate target for consumers' future demands. The losses can be significant if a product is developed for a market that doesn't demand it.

Product companies have traditionally relied on consumer clinics, surveys, and experience to determine the future demands, with varying degrees of success. However, these prior art methods have severe deficiencies including too few data points and fairly infrequent capture of data points. These companies can benefit from any method that improves the accuracy of predicting future requirements for their products.

Recently, the Internet has provided a tool for accessing significantly large numbers of people as never seen before. Thus, the Internet can be used as a tool for collecting input from extremely large numbers of people. It would, therefore, be desirable to provide a method, system, and computer program product that utilizes the Internet in predicting product requirements to reduce the risk involved in determining which products to produce and inhibit the development of products that will not be desired by a large enough number of consumers at the time of product delivery to be profitable.

### SUMMARY OF THE INVENTION

The present invention provides a method, system, and computer program product for capturing and analyzing consumer product preferences over a period of time in order to predict future product and service requirements. In one embodiment, individual consumer product preference inputs from a plurality of consumers are collected over time via a user-interface tool, such as, for example, a web-based tool. The inputs are stored in a storage unit, such as, for example, a database. After a specified period of time or after a threshold number of inputs have been received, the consumer product preference inputs are retrieved from the storage unit and reduced into representative clusters to facilitate predicting future product requirements and to do trend analysis to extrapolate the change of the cluster over time.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIGS. 1A-1B depict diagrams of an exemplary user interface illustrating how a consumer can use a web-based tool to describe their preferred product characteristics in accordance with one embodiment of the present invention;

FIG. 2 depicts an exemplary process flow and program function diagram illustrating the overall process of predicting the product requirements in accordance with one embodiment of the present invention;

FIG. 3 depicts a simple exemplary diagram of data points collected from users in accordance with one embodiment of the present invention;

FIGS. 4 and 5 depict exemplary diagrams illustrating how data points can be clustered by their proximity via autonomous clustering and represented by each cluster's centroid in accordance with one embodiment of the present invention;

FIG. 6 depicts an exemplary diagram showing how the clustered data, stored in sets, can be used to plot the changes in preferred product requirements and characteristics over time, and used to extrapolate the historical data from the present time into a future time in accordance with one embodiment of the present invention;

FIG. 7 depicts a pictorial representation of a distributed data processing system in which the present invention may be implemented;

FIG. 8 depicts a block diagram of a data processing system which may be implemented as a server in accordance with the present invention; and

FIG. 9 depicts a block diagram of a data processing system in which the present invention may be implemented.

### DETAILED DESCRIPTION OF THE PREFERRED EMBODIMENT

The dynamic nature of the consumer demands and the length of time for product development create a challenge for product manufacturers. In order to fulfill the needs of the consumers, and to be profitable, product manufacturers must predict the requirements for their new products as early as possible. This is particularly critical for products with a long development time. Traditional market analysis techniques have included consumer surveys and clinics, statistical analysis, and the experience of seasoned marketing professionals. These techniques have deficiencies rooted in limited number of participants, personal biases, and analysis of data with low integrity.

Several existing technologies have converged to create a foundation for a more effective tool for predicting product requirements. The web-based tool described in U.S. patent application no. 20030078859, which is hereby incorporated herein by reference for all purposes, provides a means to capture product preferences from a large number of consumers. The automated pattern recognition technique disclosed in U.S. Pat. No. 5,933,818, which is hereby incorporated herein by reference for all purposes, provides analytical tools for clustering similar data. Commercially available analysis trend analysis tools (such as, for example, products by SAS) can further be applied to the clustered data in order to forecast product characteristics at some point in the future along with the associated confidence factor.

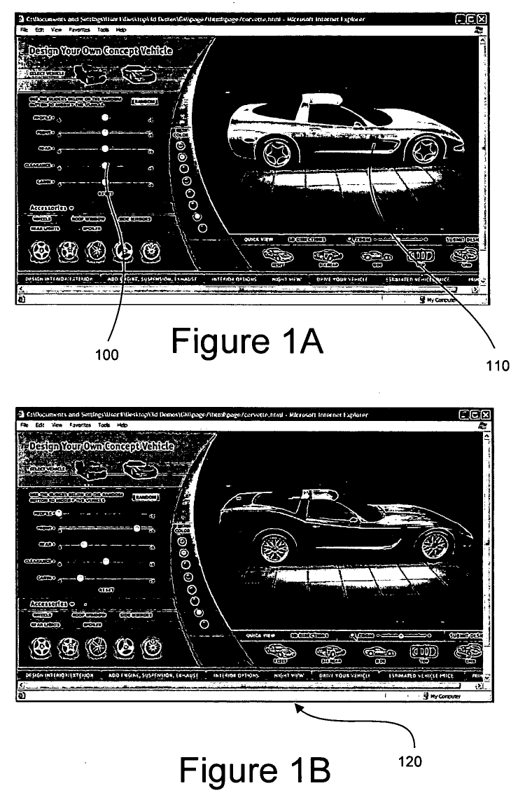

The first step in the process of predicting requirements analysis is capturing inputs from consumers. With reference now to the figures and, in particular, with reference to FIGS. 1A-1B, diagrams of an exemplary user interface illustrating how a consumer can use a web-based tool to describe their preferred product characteristics is depicted in accordance with one embodiment of the present invention. The web-based tool can provide various controls 100 to change the desired characteristics of the product 110. Examples of such controls are color, shape of wheels, type of fender etc. The final product 120 represents the preferred characteristics of the product that best appeal to the consumer.

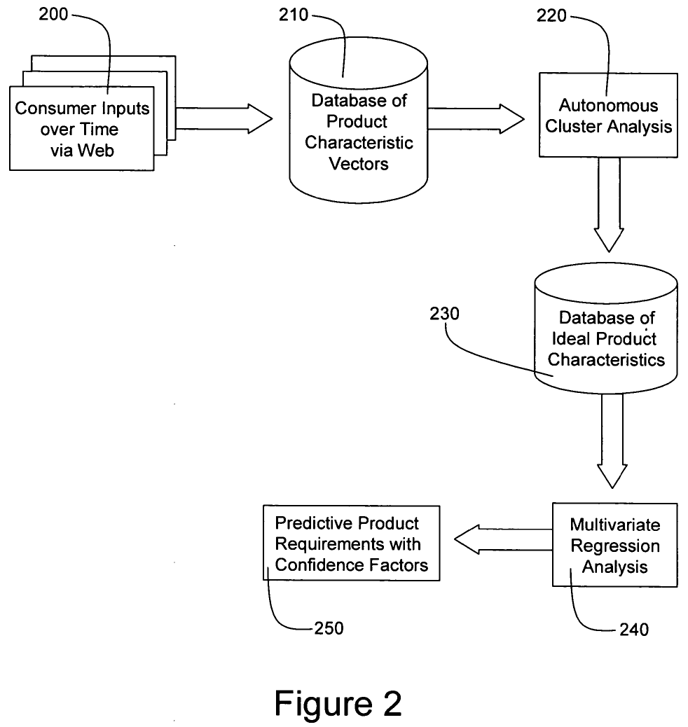

With reference now to FIG. 2, an exemplary process flow and program function diagram illustrating the overall process of predicting the product requirements is depicted in accordance with one embodiment of the present invention. The consumer's incentive to access the web-based tool to provide inputs regarding the preferred product characteristics 200 may be provided by, for example, promotions such as coupons or discounts, or just the simple entertainment value.

A database 210 captures and stores the consumers' inputs via, for example, at least one data structure and at least one data table. The captured data may include, for example, product information, product characteristics, consumers' demographic data (such as age, gender, location etc.), and time. The database 210 may optionally implement data management tools for data modeling, data cleansing, and data warehousing. Autonomous cluster analysis 220 (see U.S. Pat. No. 5,933,818 which is hereby incorporate by reference for all purposes) reduces large volumes of data in the database 210 to a few representative clusters for subsequent analysis. The clusters are stored in a database of ideal product characteristics 230 along with temporal information. When a sufficient amount of data is collected over a period of time, this database 230 can be analyzed for temporal patterns using statistical techniques such as multivariate regression 240. The resulting output is a new set of product characteristics and confidence factors 250 based on an extrapolation of the consumer supplied data 210, and subsequent clustering 220 and analysis 240.

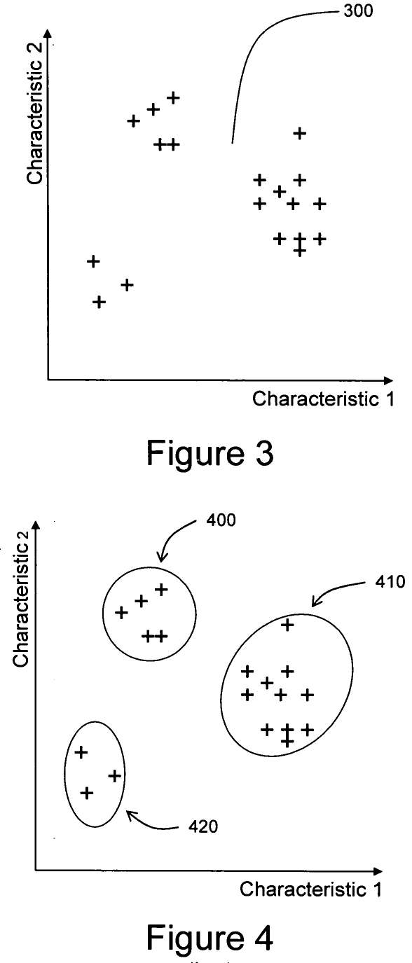

With reference now to FIG. 3, a simple exemplary diagram of data points collected from users is depicted in accordance with one embodiment of the present invention. In this example, only two product characteristics are utilized. Various data points 300 collected from consumers and stored in the database 210 are displayed.

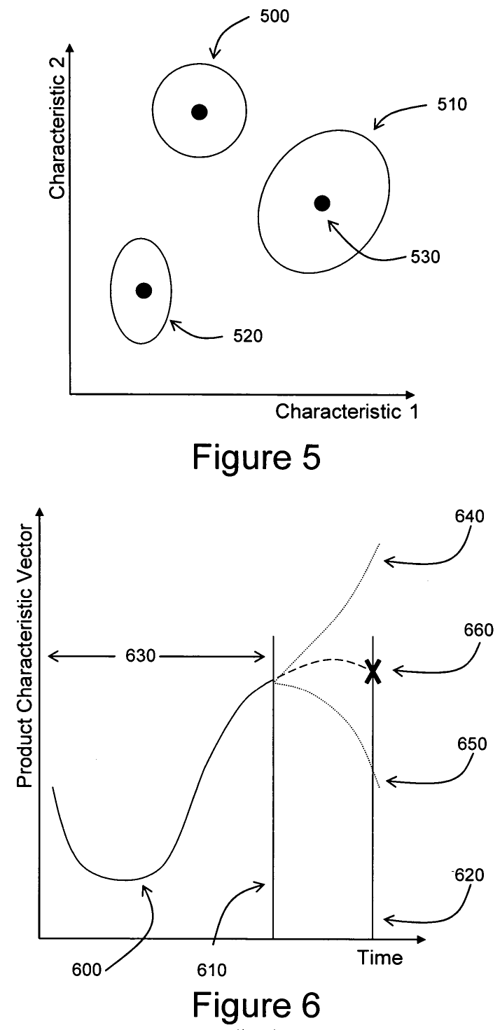

With reference now to FIGS. 4 and 5, exemplary diagrams illustrating how data points can be clustered 400, 410, 420 by their proximity via autonomous clustering 220 and represented by each cluster's centroid 530 are depicted in accordance with one embodiment of the present invention. In the example depicted in FIG. 5, all the input data are reduced to only three typical clusters 500, 510, 520.

With reference now to FIG. 6, an exemplary diagram showing how the clustered data, stored in sets, can be used to plot the changes in preferred product requirements and characteristics 600 over time, and used to extrapolate the historical data 630 from the present time 610 into a future time 620 is depicted in accordance with one embodiment of the present invention. The resulting set of characteristics 660 defines the future requirements, and an upper limit 640 and a lower limit 650 are also calculated to define the confidence range.

The basic process is as shown in the following example:

The characteristics of a product may be defined by the configuration vector \vec{C} (t),
\vec{C}(t)={p₁εP₁,p₂εP₂, . . . ,PₘεPₙ,Tₖ}

Where P represents sets of characteristics for a class of products, and p defines the unique characteristics of a single product for each P and Tₖ defines a unique time K. For example, P₁ may represent the Color, and P₂ may represent the Length of a product. P can be a set of discrete characteristics (e.g., Blue, Green, Red for P₁=Color), or a range of continuous data (e.g., 5″-10″ for P₂=Length).

For example, a product with characteristics such as Color, Length, Size, Finish, Date may be defined as, \vec{C}(t)={Blue, 5.7, Small, Smooth, Nov. 1, 2004}. These product characteristics may be stored in a database over a period of time.

An interface with the consumers, such as a web-based tool, may be used to capture the consumers' ideal product characteristics over a period of time (see, for example, US Patent Application no. 20030078859). Such an interface may further offer usage incentives such as entertainment, coupons, discounts etc., to encourage consumer participation.

In one such application, a vehicle such as a Corvette may be displayed, along with characteristics such as color, engine type, variable geometric attributes, wheels etc., and the consumers can provide their ideal configurations for this vehicle type.

Over time, a database of a product's characteristic vectors (\vec{C} (t)) can be developed based on consumer inputs, along with additional attributes such as demographic, geographic, and date/time. When a sufficient number of these vectors are collected over time, it will become possible to not only identify the consumers' ideal product configuration, but also the changes or trends. The knowledge of the trends in product characteristics can be extrapolated and used to define future states of product characteristics, along with degrees of confidence. The future states of a product's characteristics essentially predict the consumer demand (or requirements) for that product at various times in the future.

To accomplish this task, a database of \vec{C} (t) is subjected to autonomous cluster analysis (see, for example, U.S. Pat. No. 5,933,818) and other statistical processes (e.g., means, deviation, distributions), to discover the dominant clusters of popular product characteristics. This clustering can also be correlated with other contextual factors such as demographics (e.g., age and gender), location, and season. This autonomous cluster analysis is proposed because simple averaging of the product characteristics is likely to overlook any non-linear relationships among those characterizes.

The clusters can be further analyzed for changes over time. Using techniques, such as, for example, linear or non-linear multivariate regression, which are well known to one of ordinary skill in the art, the product characteristics can be extrapolated into a future state.

For example, for a particular product the most popular configuration for August 2003 may be discovered to be,
\vec{C}={Blue, 5.5, Medium, Smooth, August, 2003}.

However, the most popular configuration for the same product during the prior three years could have been:
\vec{C}={Blue, 5.25, Medium, Smooth, August, 2005} for August 2005
\vec{C}={Blue, 5.1, Medium, Rough. August. 2004} for August 2004
\vec{C}={Red, 5.0, Medium, Rough, August, 2003} for August 2003

Thus, using regression analysis, it can be predicted that the most popular product configuration in August 2004 will be,
\vec{C}={Blue, 5.8, Medium, Extra Smooth} with a confidence of 80% and for August 2005,
\vec{C}={Blue, 6.2, Medium, Extra Smooth} with a confidence of 55%

The advantage of this predictive process is that the consumers only express their preferences at any point in time, and the process leverages their collective inputs over a period of time to extrapolate and define a future state of the requirements. The advantages of this method are obvious when contrasted with the prior art in which clinics and surveys are conducted asking potential consumers to speculate about what they may like in the future. People can say with certainty what they would like now, but must speculate about what they may like in the future.

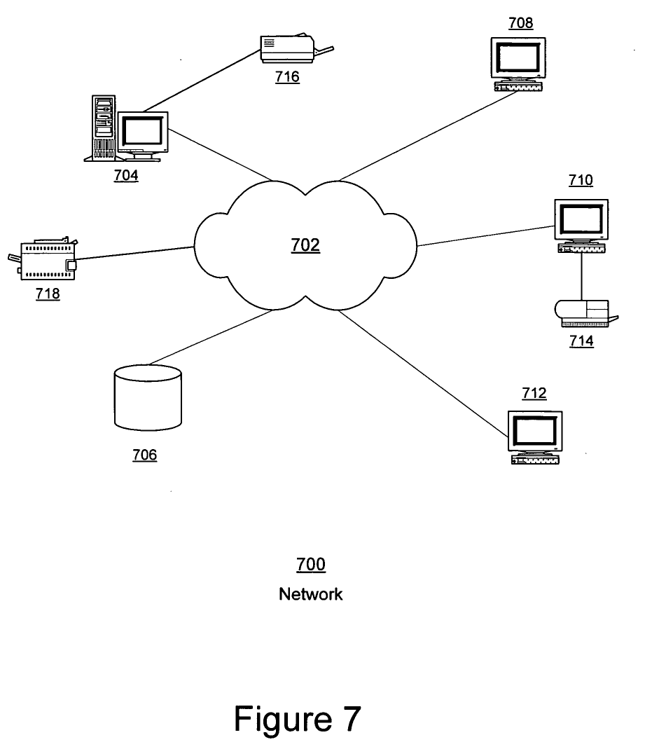

With reference now to FIG. 7, a pictorial representation of a distributed data processing system is depicted in which the present invention may be implemented. Distributed data processing system 700 is an example of a system that may be utilized by an enterprise in order to collect consumer preferences for predictive product requirement analysis in accordance with the present invention. Distributed data processing system 700 is a network of computers in which the present invention may be implemented. Distributed data processing system 700 contains network 702, which is the medium used to provide communications links between various devices and computers connected within distributed data processing system 700. Network 702 may include permanent connections, such as wire or fiber optic cables, or temporary connections made through telephone connections.

In the depicted example, server 704 is connected to network 702, along with storage unit 706. In addition, clients 708, 710 and 712 are also connected to network 702. These clients, 708, 710 and 712, may be, for example, personal computers or network computers. For purposes of this application, a network computer is any computer coupled to a network that receives a program or other application from another computer coupled to the network. In the depicted example, server 704 provides data, such as boot files, operating system images and applications, to clients 708-712. Clients 708, 710 and 712 are clients to server 704. Distributed data processing system 700 may include additional servers, clients, and other devices not shown. Distributed data processing system 700 also includes printers 714, 716 and 718. A client, such as client 710, may print directly to printer 714. Clients such as client 708 and client 712 do not have directly attached printers. These clients may print to printer 716, which is attached to server 704, or to printer 718, which is a network printer that does not require connection to a computer for printing documents. Client 710, alternatively, may print to printer 716 or printer 718, depending on the printer type and the document requirements.

In the depicted example, distributed data processing system 700 is the Internet, with network 702 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 700 also may be implemented as a number of different types of networks such as, for example, an intranet or a local area network.

FIG. 7 is intended as an example and not as an architectural limitation for the processes of the present invention.

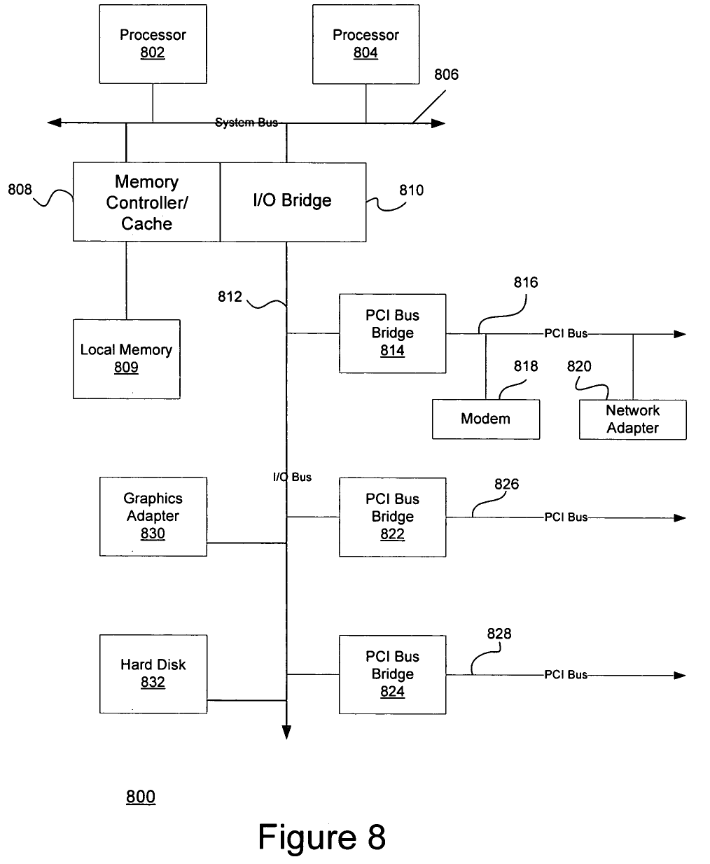

Referring to FIG. 8, a block diagram of a data processing system which may be implemented as a server, such as server 704 in FIG. 7, is depicted in accordance with the present invention. Data processing system 800 may be a symmetric multiprocessor (SMP) system including a plurality of processors 802 and 804 connected to system bus 806. Alternatively, a single processor system may be employed. Also connected to system bus 806 is memory controller/cache 808, which provides an interface to local memory 809. I/O bus bridge 810 is connected to system bus 806 and provides an interface to I/O bus 812. Memory controller/cache 808 and I/O bus bridge 810 may be integrated as depicted. Peripheral component interconnect (PCI) bus bridge 814 connected to I/O bus 812 provides an interface to PCI local bus 816. A number of modems 818-820 may be connected to PCI bus 816. Typical PCI bus implementations will support four PCI expansion slots or add-in connectors. Communications links to network computers 708-712 in FIG. 7 may be provided through modem 818 and network adapter 820 connected to PCI local bus 816 through add-in boards.

Additional PCI bus bridges 822 and 824 provide interfaces for additional PCI buses 826 and 828, from which additional modems or network adapters may be supported. In this manner, server 800 allows connections to multiple network computers. A memory mapped graphics adapter 830 and hard disk 832 may also be connected to I/O bus 812 as depicted, either directly or indirectly.

Those of ordinary skill in the art will appreciate that the hardware depicted in FIG. 8 may vary. For example, other peripheral devices, such as optical disk drives and the like, also may be used in addition to or in place of the hardware depicted. The depicted example is not meant to imply architectural limitations with respect to the present invention.

Data processing system 800 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries.

Data processing system 800 may be implemented as a web server for providing a user interface to consumer's such that consumer's may provide their product preferences to an enterprise for predictive product requirement analysis in accordance with the present invention.

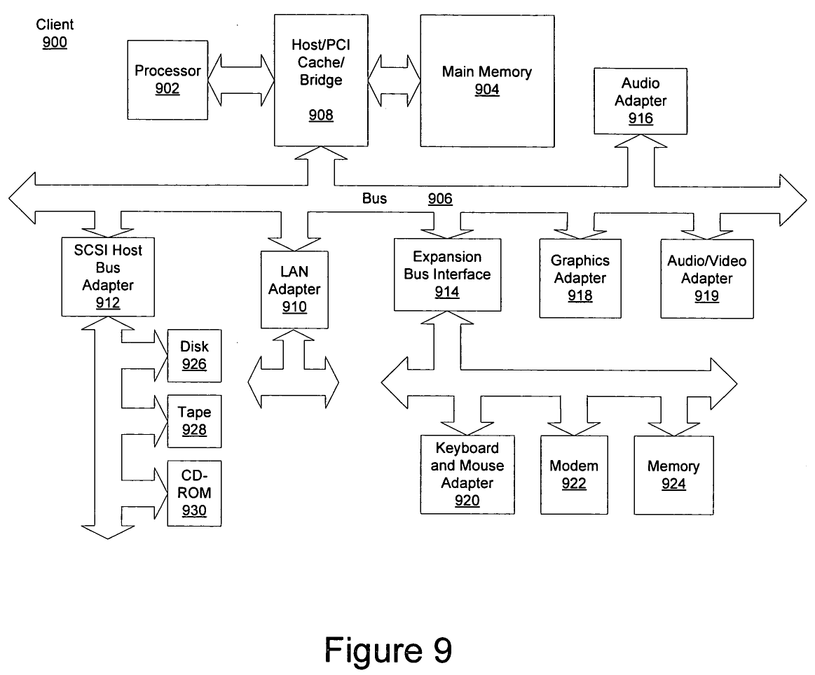

With reference now to FIG. 9, a block diagram of a data processing system in which the present invention may be implemented is illustrated. Data processing system 900 is an example of a client computer that may be utilized by a consumer to access an enterprise's web site to provide aid in providing predictive product demand information in accordance with the present invention. Data processing system 900 employs a peripheral component interconnect (PCI) local bus architecture. Although the depicted example employs a PCI bus, other bus architectures, such as Micro Channel and ISA, may be used. Processor 902 and main memory 904 are connected to PCI local bus 906 through PCI bridge 908. PCI bridge 908 may also include an integrated memory controller and cache memory for processor 902. Additional connections to PCI local bus 906 may be made through direct component interconnection or through add-in boards. In the depicted example, local area network (LAN) adapter 910, SCSI host bus adapter 912, and expansion bus interface 914 are connected to PCI local bus 906 by direct component connection. In contrast, audio adapter 916, graphics adapter 918, and audio/video adapter (A/V) 919 are connected to PCI local bus 906 by add-in boards inserted into expansion slots. Expansion bus interface 914 provides a connection for a keyboard and mouse adapter 920, modem 922, and additional memory 924. In the depicted example, SCSI host bus adapter 912 provides a connection for hard disk drive 926, tape drive 928, CD-ROM drive 930, and digital video disc read only memory drive (DVD-ROM) 932. Typical PCI local bus implementations will support three or four PCI expansion slots or add-in connectors.

An operating system runs on processor 902 and is used to coordinate and provide control of various components within data processing system 900 in FIG. 9. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 900. Instructions for the operating system, the object-oriented operating system, and applications or programs are located on a storage device, such as hard disk drive 926, and may be loaded into main memory 904 for execution by processor 902.

Those of ordinary skill in the art will appreciate that the hardware in FIG. 9 may vary depending on the implementation. For example, other peripheral devices, such as optical disk drives and the like, may be used in addition to or in place of the hardware depicted in FIG. 9. The depicted example is not meant to imply architectural limitations with respect to the present invention. For example, the processes of the present invention may be applied to multiprocessor data processing systems.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, CD-ROMs, data DVD, thumb drives, and network storage and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for capturing consumer product preferences over a period of time and predicting future requirements, the method comprising:
collecting individual consumer product preference inputs from a plurality of consumers via a user-interface tool;
storing the inputs in a storage unit; and
reducing the consumer product preference inputs retrieved from the storage unit into representative clusters to facilitate predicting product requirements.

2. The method as recited in claim 1, wherein said user-interface tool is a web-based tool accessible via the Internet.

3. The method as recited in claim 2, wherein said web-based tool provides visual means for viewing, inspecting, and changing a product's characteristics.

4. The method as recited in claim 1, further comprising providing incentives to the consumer for using the user-interface tool.

5. The method as recited in claim 2, wherein said web-based tool collects consumers' product preferences on many instances over a period of time.

6. The method as recited in claim 1, wherein said the storage unit comprises a database and the database consists of at least one data structure and at least one data table to store the inputs the consumers provide via the user-interface tool.

7. The method as recited in claim 6, wherein the database is supported by data management services to ensure effective representation, modeling, and integrity of the data.

8. The method as recited in claim 1, wherein the reduction of the data is accomplished via data clustering techniques.

9. The method as recited in claim 8, wherein the data clustering technique comprises one of the Kohonen Network algorithm and the K-Means algorithm.

10. The method as recited in claim 8, further comprising analyzing the statistical analysis of the data in at least one cluster to obtain predictive product information to summarize and represent the content of at least one of the clusters.

11. The method as recited in claim 10, wherein the predictive product information comprises one of cluster center and cluster population.

12. A method for predictive product requirements analysis and predicting future requirements, the method comprising:
analyzing trends in changes of consumer preferences over time;
mapping sets of consumer preferences into long-term product requirements;
calculating confidence factors for the predicted product requirements; and
reporting the predicted product requirements.

13. The method as recited in claim 12, wherein the analyzing trends in changes of consumer preferences over time monitors the changes of consumers preferences over a period of time, extrapolates the future state of the preferences based on the historical data collected, and summarizes the results.

14. The method as recited claim 12, wherein said consumer preferences are extrapolated to define a future state of the product's feature and these features are set as the requirements for that product at a future point in time.

15. The method as recited in claim 12, wherein said the prediction of future product requirements has an associated confidence factor.

16. The method as recited in claim 15, wherein the associated confidence factor depends on at least one of the original population size, the degrees of historical variations, and the extent of projection into the future.

17. The method as recited in claim 12, wherein the reports organize the extrapolated future requirements and the confidence in the prediction in a manner suitable for viewing by the user.

18. A computer program product in a computer readable media for use in a data processing system for capturing consumer product preferences over a period of time and predicting future requirements, the computer program product comprising:
first instructions for collecting individual consumer product preference inputs from a plurality of consumers via a user-interface tool;
second instructions for storing the inputs in a storage unit; and
third instructions for reducing the consumer product preference inputs retrieved from the storage unit into representative clusters to facilitate predicting product requirements.

19. The computer program product as recited in claim 18, wherein said user-interface tool is a web-based tool accessible via the Internet.

20. The computer program product as recited in claim 19, wherein said web-based tool provides visual means for viewing, inspecting, and changing a product's characteristics.

21. The computer program product as recited in claim 18, further comprising providing incentives to the consumer for using the user-interface tool.

22. The computer program product as recited in claim 19, wherein said web-based tool collects consumers' product preferences on many instances over a period of time.

23. The computer program product as recited in claim 18, wherein said the storage unit comprises a database and the database consists of at least one data structure and at least one data table to store the inputs the consumers provide via the user-interface tool.

24. The computer program product as recited in claim 23, wherein the database is supported by data management services to ensure effective representation, modeling, and integrity of the data.

25. The computer program product as recited in claim 18, wherein the reduction of the data is accomplished via data clustering techniques.

26. The computer program product as recited in claim 25, wherein the data clustering technique comprises one of the Kohonen Network algorithm and the K-Means algorithm.

27. The computer program product as recited in claim 25, further comprising analyzing the statistical analysis of the data in at least one cluster to obtain predictive product information to summarize and represent the content of at least one of the clusters.

28. The computer program product as recited in claim 27, wherein the predictive product information comprises one of cluster center and cluster population.

29. A computer program product in a computer readable media for use in a data processing system for predictive product requirements analysis and predicting future requirements, the computer program product comprising:
first instructions for analyzing trends in changes of consumer preferences over time;
second instructions for mapping sets of consumer preferences into long-term product requirements;
third instructions for calculating confidence factors for the predicted product requirements; and
fourth instructions for reporting the predicted product requirements.

30. The computer program product as recited in claim 29, wherein the analyzing trends in changes of consumer preferences over time monitors the changes of consumers preferences over a period of time, extrapolates the future state of the preferences based on the historical data collected, and summarizes the results.

31. The computer program product as recited claim 29, wherein said consumer preferences are extrapolated to define a future state of the product's feature and these features are set as the requirements for that product at a future point in time.

32. The computer program product as recited in claim 29, wherein said the prediction of future product requirements has an associated confidence factor.

33. The computer program product as recited in claim 32, wherein the associated confidence factor depends on at least one of the original population size, the degrees of historical variations, and the extent of projection into the future.

34. The computer program product as recited in claim 29, wherein the reports organize the extrapolated future requirements and the confidence in the prediction in a manner suitable for viewing by the user.

35. A system for capturing consumer product preferences over a period of time and predicting future requirements, the system comprising:
first means for collecting individual consumer product preference inputs from a plurality of consumers via a user-interface tool;
second means for storing the inputs in a storage unit; and
third means for reducing the consumer product preference inputs retrieved from the storage unit into representative clusters to facilitate predicting product requirements.

36. The system as recited in claim 35, wherein said user-interface tool is a web-based tool accessible via the Internet.

37. The system as recited in claim 36, wherein said web-based tool provides visual means for viewing, inspecting, and changing a product's characteristics.

38. The system as recited in claim 35, further comprising providing incentives to the consumer for using the user-interface tool.

39. The system as recited in claim 36, wherein said web-based tool collects consumers' product preferences on many instances over a period of time.

40. The system as recited in claim 35, wherein said the storage unit comprises a database and the database consists of at least one data structure and at least one data table to store the inputs the consumers provide via the user-interface tool.

41. The system as recited in claim 40, wherein the database is supported by data management services to ensure effective representation, modeling, and integrity of the data.

42. The system as recited in claim 35, wherein the reduction of the data is accomplished via data clustering techniques.

43. The system as recited in claim 42, wherein the data clustering technique comprises one of the Kohonen Network algorithm and the K-Means algorithm.

44. The system as recited in claim 42, further comprising analyzing the statistical analysis of the data in at least one cluster to obtain predictive product information to summarize and represent the content of at least one of the clusters.

45. The system as recited in claim 44, wherein the predictive product information comprises one of cluster center and cluster population.

46. A system for predictive product requirements analysis and predicting future requirements, the system comprising:
first means for analyzing trends in changes of consumer preferences over time;
second means for mapping sets of consumer preferences into long-term product requirements;
third means for calculating confidence factors for the predicted product requirements; and
fourth means for reporting the predicted product requirements.

47. The system as recited in claim 46, wherein the analyzing trends in changes of consumer preferences over time monitors the changes of consumers preferences over a period of time, extrapolates the future state of the preferences based on the historical data collected, and summarizes the results.

48. The system as recited claim 46, wherein said consumer preferences are extrapolated to define a future state of the product's feature and these features are set as the requirements for that product at a future point in time.

49. The system as recited in claim 46, wherein said the prediction of future product requirements has an associated confidence factor.

50. The system as recited in claim 49, wherein the associated confidence factor depends on at least one of the original population size, the degrees of historical variations, and the extent of projection into the future.

51. The system as recited in claim 46, wherein the reports organize the extrapolated future requirements and the confidence in the prediction in a manner suitable for viewing by the user.
